(19) United States
(12) Patent Application Publication
(10) Pub. No.: US 2010/0220430 A1
(43) Pub. Date: Sep. 2, 2010

(54) SUPERCAPACITOR ELECTRODE USING ION-EXCHANGER

(75) Inventors: Jun-Hee BAE, Suwon-si (KR); Seung-Hyun Ra, Seongnam-si (KR); Hak-Kwan Kim, Hanam-si (KR); Hyun-Chul Jung, Yongin-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/646,447

(22) Filed: Dec. 23, 2009

(30) Foreign Application Priority Data
Mar. 2, 2009 (KR) 10-2009-0017612

(51) Int. Cl. H01G 9/155

(52) U.S. Cl. 361/502; 427/80

(57) ABSTRACT

It relates to a supercapacitor using an ion-exchanger, particularly to a supercapacitor which may optimize the capacity of current collection by employing an ion-exchanger instead of a binder in manufacturing of supercapacitor electrodes.

### CROSS-REFERENCE TO RELATED APPLICATIONS

This application claims the benefit of Korean Patent Application No. 10-2009-0017612 filed with the Korean Intellectual Property Office on Mar. 2, 2009, the disclosure of which is incorporated herein by reference in its entirety.

### BACKGROUND

1. Technical Field

It relates to a supercapacitor electrode, particularly to a supercapacitor electrode which may optimize the capacity of current collection by employing an ion-exchanger instead of a binder in manufacturing of supercapacitor electrodes.

2. Description of the Related Art

Higher value-added businesses, which collect and use various and useful information in real time by employing IT equipments, receive attentions and stable energy supply for securing reliability of such systems becomes an important factor in the information-oriented society.

As part of obtaining such energy supplies, a battery, which is the most general energy storing device, is widely used since it is able to store quite a bit of energy in relatively small volume and weight and provide an appropriate output in various uses. However, the battery has common disadvantages of low storage characteristics and low cycle life regardless of types of batteries. Such disadvantages are caused by natural degradation of chemicals inside the battery or deterioration with use. There has been no alternative but to use with accepting such disadvantages.

A supercapacitor, which is a capacitor with very high capacity, unlike the battery which stores energy by the electro-chemical process, is an energy storage device using an electrical double layer which is formed between an electrode and an electrolyte. The supercapacitor stores energy through surface absorption of charges in which the charge absorption takes place in the interface between an electrode and an electrolyte. Since it undergoes very fast charge and discharge and provides high charge and discharge efficiency and semi-permanent cycle life, it is receiving a great deal of attention as an excellent supplement of auxiliary batteries or batteries.

The supercapacitor is composed of electrodes, an electrolyte, a current collector, and a separator and is based on the electrochemical mechanism which stores energy through absorption of electrolyte ions on the electrode surface by migrating along with the electric field when voltages are applied on the both ends of a unit cell electrode.

Various materials have been used for electrodes of the supercapacitor. The most basic materials for the electrode are a carbon electrode material (active material), a conducting agent and a polymer binder. A slurry of these materials is coated on a current collector to provide an electrode. Here, the binder is important to bind between active materials and between the current collector and the electrode materials. However, channels for ions to move into the active material can be blocked due to use of the binder, which further causes decrease of the capacity of the supercapacitor.

Even though the supercapacitor allows very fast charge and discharge and provides high charge and discharge efficiency and semi-permanent cycle life, it has still limitation in its applications due to use of the binder which deteriorates the capacity. Therefore, it is highly demanded to develop novel supercapacitors with improved capacity for its wide applications.

### SUMMARY

It is to improve the capacity of a supercapacitor by selectively transferring only desired ions through an active material with using a cation-exchanger at the cathode and an anion-exchanger at the anode, instead of using a binder so that it may eliminate interruption of ion transfer caused by using a binder.

In order to achieve the above aspect, a supercapacitor electrode may be manufactured by using an ion-exchanger, instead of a known binder, such as using a cation-exchanger at the cathode and an anion-exchanger at the anode.

According to an embodiment, it provides a supercapacitor including a current collector which permits direct current; a porous separator; a cathode manufactured by including a porous activated carbon material, a conducting agent and a cation-exchanger; and an anode manufactured by including a porous activated carbon material, a conducting agent and an anion-exchanger.

In the supercapacitor herein, both electrodes of cathode and anode may be manufactured by preparing a slurry mixture including a porous activated carbon material, a conducting agent, an ion-exchanger and a solvent and coating a current collector layer by layer with the result.

The slurry mixture may include 30-40 wt. % of the porous activated carbon material, 1-5 wt. % of the conducting agent, 1-5 wt. % of the ion-exchanger and 50-60 wt. % of the solvent, based on 100 wt. % of the slurry mixture.

The electrode material layer coated on the current collector may have a thickness of 50-200 μm.

The conducting agent may be at least one chosen from granulated acetylene black, super P black, carbon black, hard carbon, soft carbon, graphite and metal powder.

The porous activated carbon material may be at least one chosen from carbon coconut shell, petrolic or coal pitch, cokes, phenol resin and polyvinyl chloride.

The cation-exchanger may be poly(2-sulfoethyl methacrylate), poly(diallyldimethylammonium chloride), poly(styrene sulfonate), poly(phosphazene sulfonate), sulfonated polyimide, sulfonated polyphenylene oxide, poly(dimethyl phenylene oxide)propionic acid, sulfonated polyurethane, sulfonated polyether sulfone, sulfonated poly(benzimidazole), sulfonated poly(4-phenoxy benzoyl-1,4-phenylene), sulfonated polypropylene, sulfonated polymethyl methacrylate, fluoropolymer or fluoro copolymer-type sulfonated tetrafluoromethylene, such as poly(tetrafluoroethylene-co-sulfonated vinylidene fluoride), poly(2,4-dimethylphenylene oxide)propenoic acid, sulfonated polyurethane, sulfonated poly(ether ether ketone).

The anion-exchanger may be a gel-form or marcroporous polymer material having a functional group chosen from a quaternary ammonium functional group(chloride, hydroxide or carbonate form), a dialkylamino or substituted dialkylamino functional group(free base or acid salt form), and an aminoalkylphosphonate or aminodiacetate functional group. Further, the quaternary ammonium base may be a substituted polystyrene resin and/or a primary, secondary or tertiary amine-substituted polystyrene resin. Further, PVA (polyvinyl alcohol) may be introduced with a 4-formyl-1-methylpyridium benzenesulfonate, an ammonium group or a pyridinium group.

Further, according to another embodiment, there is provided a method for manufacturing an electrode for supercapacitors including: preparing a slurry by mixing a porous activated carbon material, a conducting agent, and an ion-exchanger in a solvent and stirring the result; coating a current collector with the slurry with an appropriate thickness and drying the result; and pressurizing the dried shiny.

The supercapacitor having electrodes manufactured by using ion-exchanger instead of a binder may allow selective transfer of desired ions from the anode and the cathode and eliminate the hindrance of ion transfer caused by the space taken by the binder, so that it may provide excellent effect to enlarge the electric capacity.

### BRIEF DESCRIPTION OF THE DRAWINGS

FIG. 1 is a schematic view of a known electric double layer supercapacitor.

FIG. 2 is a schematic view of a supercapacitor according to an embodiment.

FIG. 3 is a graph comparing each result output from a supercapacitor manufactured by using an ion-exchanger instead of using a binder according to Example 1, a supercapacitor manufactured by using an ion-exchanger at one side of anodes according to Comparison Example 2, or a supercapacitor manufactured by using a binder according to Comparison Example 1.

### DETAILED DESCRIPTION

Hereinafter, although more detailed descriptions will be given with reference to the accompanying drawings, those are only for explanation and there is no intention to limit the invention.

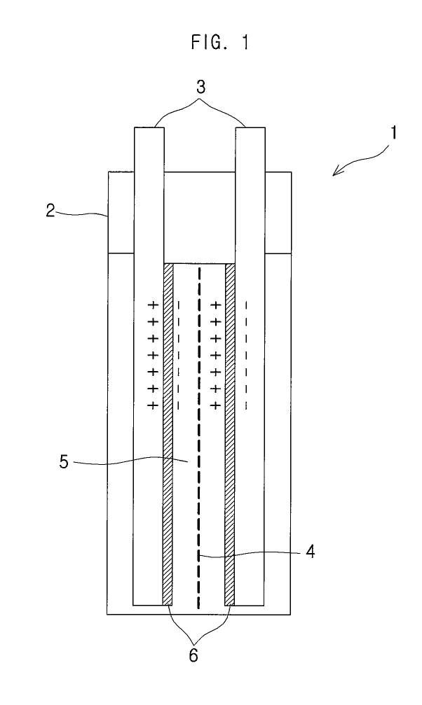

According to FIG. 1, a conventional electrical double-layer supercapacitor 1 includes a gasket 2 for sealing the outside of the supercapacitor, a porous separator 4 therein, current collectors 3 positioned opposite to the both sides of the separator 4 and allowing DC (direct current) voltage, and electrodes 6 formed by coating on the current collector 3 with an electrode slurry material (slash portions).

When several volts of voltage are supplied to the current collector 3, where both ends of the electrodes are connected, in the conventional supercapacitor, an electric field is generated and ions in an electrolyte move to be absorbed on the surface of the electrode, so that energy is charged by the electrochemical mechanism which stores energy. A supercapacitor herein also uses the identical structure and principle.

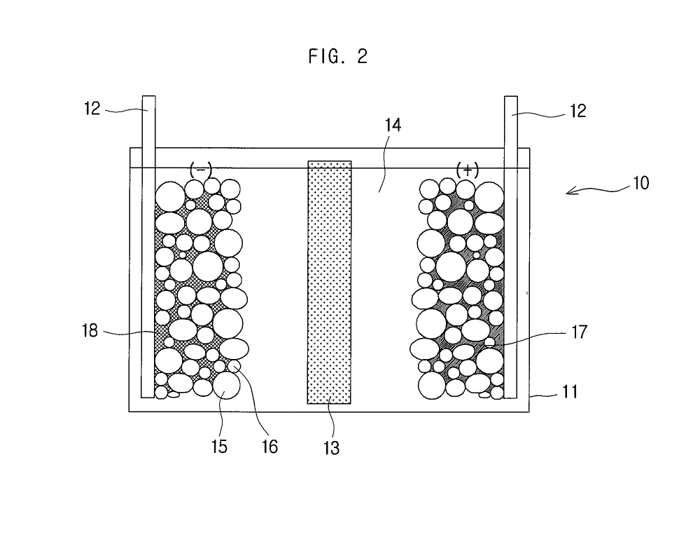

FIG. 2 is a schematic view of a supercapacitor according to an embodiment. The electrode portion coated on a current collector 12 is enlarged in order to explain in more detail. The electrode is formed by preparing a slurry mixed with an active carbon 15 having a large granular structure, a conducting agent 16 having a small granular structure, and an ion-exchanger (anion-exchanger 17 at the anode and an cation-exchanger 18 at the cathode, in a solvent and coating on the current collector with the result. The anode and cathode of FIG. 2 may be changed since they are only selected to illustrate the anion-exchanger 17 and the cation-exchanger 18. When the slurry electrode material is coated on the current collector, it may be coated layer by layer. The thickness of the electrode may be 50-200 μm. When the electrode is coated more than or less than the above range of the thickness, desired charging effects may not be obtained.

Components and materials of the supercapacitor used in the electrode will be described in detail hereinafter.

Current Collector

A material for the current collector 12 may be a metal, which does not cause dissolution/deposition within a used voltage range, such as aluminum, titanium, nickel, stainless steel and the like, a conductive polymer film, or a nonmetal such as conductive filler-containing plastic film and the like. An aluminum plate-type or thin-type, which is able to prevent resistance increase during being used and cheap, may be used.

Electrode

Porous Activated Carbon Material (Active Material)

A carbonaceous material used herein may be anything which can be activated with active carbon but is not limited thereto. An example of the carbonaceous material may include carbon coconut shell, petrolic and/or coal pitch(coal pitch), cokes, phenol resin, polyvinyl chloride and the like. The carbonaceous material may be granular type, mictroparticulate type, fibrous type, sheet type and the like but is not limited thereto.

Examples of fibrous or sheet carbonaceous material may include natural cellulose fiber such as cotton; regenerated cellulose fiber such as viscose rayon, polynosic rayon and the like; pulp fiber; synthetic fiber such as polyvinyl alcohol fiber, polyethylene-vinyl alcohol fiber and the like, and woven fabric, nonwoven fabric, film, felt and sheet of the above fibers.

Active carbon may be prepared by activating a carbonaceous material. Any known activation method may be used. For example, the carbonaceous material may be activated with a chemical having an oxidation ability such as zinc chloride, phosphorous acid, sulfuric acid, calcium chloride, sodium hydroxide, potassium dichromate, potassium permanganate and the like (chemical activation); or a exhaust gas generated from a combustion gas which is a mixture of water vapor, propane gas, CO₂ and H₂O, carbon dioxide gas (air activation).

Conducting Agent

An example of the conducting agent may include at least one or a mixture of at least two chosen from granular acetylene black, super P black, carbon black, hard carbon, soft carbon, graphite, metal powder (Al, Pt, Ni, Cu, Au, stainless steel or an alloy including at least one of the metals described), metal powder prepared by coating the described metal with carbon black, active carbon, hard carbon, soft carbon, or graphite by the electroless plating.

Cation-Exchange Material

A cation-exchanger 18 used here is a material which is negatively charged material and thus permits cations but hold anions to pass through a membrane. Generally, a cation-exchanger used in supercapacitors is needed to have low electrical resistance, excellent ion selective permeability, good chemical stability, and high mechanical strength.

More particularly, the cation-exchanger may be a strong acidic cation exchange material or weak acidic cation exchange material, such as poly(2-sulfoethyl methacrylate), poly(diallyldimethylammonium chloride), poly(styrene sulfonate), poly(phosphazene sulfonate), sulfonated polyimide, sulfonated polyphenylene oxide, poly(dimethylphenylene oxide)propionic acid, sulfonated polyurethane, sulfonated polyethersulfone, sulfonated poly(benzimidazole), sulfonated poly(4-phenoxy benzoyl-1,4-phenylene), sulfonated polypropylene, sulfonated polymethyl methacrylate, fluoropolymer-or fluorocopolymer-based sulfonated tetrafluoromethylene, poly(2,4-dimethylphenylene oxide)propenoic acid, sulfonated polyurethane and sulfonated poly(ether ether ketone) which can be used alone or in a combination of two or more.

Most of currently commercialized cation-exchangers are fluorinated polymers having cation exchange groups such as Nafion™ (Dupont) which is a sulfonated perfluoro-based polymer, Aciplex-S (Asahi Chemicals), Dow (Dow Chemicals), Flemion (Asahi Glass), and GoreSelcet (Gore & Associate), etc. These cation-exchangers may be also used.

Anion-Exchange Material

An anion-exchanger 17 used here is a material which is positively charged material and thus permits anions but hold cations to pass through a membrane. Generally, an anion-exchanger used in supercapacitors is needed to have low electrical resistance, excellent ion selective permeability, good chemical stability, and high mechanical strength like the cation-exchanger.

An anion-exchanger used here may be a strong basic anion exchange material (SBA), a weak basic anion exchange material (WBA), an anionic material, or a gel-form or macro porous polymer material having a functional group chosen from a quaternary ammonium functional group, a dialkylamino or substituted dialkylamino functional group and an aminoalkylphosphonate or aminodiacetate functional group. Further, a quaternary ammonium group-substituted polystyrene resin and/or a primary, secondary or tertiary amine-substituted polystyrene resin may be used. PVA having a 4-formyl-1-methylpyridium benzenesulfonate, ammonium group or pyridinium group may be also used. An example of currently commercialized anion-exchangers may include Amberlite IRA-402, Amberjet 4400 and Ambersep 900 (Rohm and Haas Comapany, Philadelphia, Pa., USA) which may be used here.

Solvent

Alcohols may be used as a solvent but it is not limited thereto. Examples of alcohols may include isopropyl alcohol, ethanol, butanol, pentanol, heptanol, propanol, hexanol and the like. An amount of the alcohol may be 50-60 wt. % based on 100 wt. % of the electrode slurry mixture.

The supercapacitor may be manufactured by preparing a slurry by mixing a porous activated carbon material, a conducting agent, an ion-exchanger and a solvent and coating a current collector with the slurry layer by layer. 30-40 wt. % of the active carbon, 1-5 wt. % of the conducting agent, 1-5 wt. % of the ion-exchanger and 50-60 wt. % of the solvent may be used based on 100 wt. % of the slurry mixture. When each amount is used more or less than the described amount, desired characteristics of electrodes of the supercapacitor may not be obtained.

Separator

A separator prevents the charge from moving between the two electrodes and is impregnated with an electrolyte. A material for the separator which can be used in the supercapacitor may be polyethylene nonwoven fabric, polypropylene nonwoven fabric, polyester nonwoven fabric, polyacrylonitrile porous separator, poly(vinylidene fluoride) hexafluoropropane copolymer porous separator, cellulose porous separator, kraft paper or rayon, etc. However, if it can be used in the filed of battery and capacitor, it may not be limited thereto.

Electrolyte

An electrolyte used in the supercapacitor according to an embodiment may be an aqueous electrolyte, a non-aqueous electrolyte or a solid electrolyte, etc.

An example of the aqueous electrolyte may include 5-100 wt. % of an aqueous sulfuric acid solution, 0.5-20 M of an aqueous potassium hydroxide solution, or 0.2-10 M of a neutral electrolyte such as an aqueous potassium chloride solution, aqueous sodium chloride solution, aqueous potassium nitrate solution, aqueous sodium nitrate solution, aqueous potassium sulfate solution and the like but is not limited thereto.

The non-aqueous electrolyte may be an organic electrolyte which is prepared by dissolving a salt composed of a cation such as tetraalkylammonium (e.g., tetraethylammonium or tetramethylarnmonium), lithium ions or potassium ions, etc. and an anion such as tetrafluoroborate, perchlorate, hexafluorophosphate, bistrifluoromethanesulfonylimide or trisfluoromethane sulphonylmethide, etc. in a nonprotonic solvent which has especially high dielectric contant(e.g.,, propylenecarbonate or ethylenecarbonate) or low viscosity (e.g., diethylcarbonate, dimethylcarbonate, ethylmethylcarbonate, dimethylether or diethylether) to be 0.5-3 M.

Further, the electrolyte may be a gel-type polymer electrolyte, which is prepared by impregnating a polymer such as polyethylene oxide, polyacrylonitrile and the like into an electrolyte, or an inorganic solid electrolyte such as LiI, Li₃N and the like.

Gasket

A material for a gasket 11 may be a resin such as ABS, butyl rubber, polyolefin resin and the like, preferably a polyolefin resin which is colorless and transparent. The polyolefin resin may satisfy chemical and thermal properties and mechanical strength for use as a gasket 11 and further since it is colorless and transparent, leakage of an electrolyte is visible with the naked eye.

In addition, according to another embodiment, there is provided a method for manufacturing an electrode for a supercapacitor, the method including: preparing a slurry by mixing a porous activated carbon material, a conducting agent, and an ion-exchanger in a solvent and stirring the result; coating a current collector with the slurry with a particular thickness and drying the result; and pressurizing the dried slurry.

First, a mixture of a solvent, an active carbon, conducting agent powder and an ion-exchanger in a mechanical stirrer is mixed and dispersed with a rate of 300 to 500 rpm to obtain a slurry having a viscosity of 1000-1500 poise. Here, 30-40 wt. % of the active carbon, 1-5 wt. % of the conducting agent, 1-5 wt. % of the ion-exchanger and 50-60 wt. % of the solvent are used.

Then, the slurry is coated to be a thickness of 50-200 μm by using an automatic film applicator and a dispenser. The coated film is dried at a temperature of 50-200° C. for 2-24 hours and the dried film is roll-pressed at a temperature of 100-150° C. to have a thickness of 50-200 μm. The result is cut according to a shape of electrodes and vacuum-dried.

Hereinafter, although the present invention will be described with reference to particular embodiments, those are only for explanation and there is no intention to limit the invention.

### EXAMPLE 1

For preparing a cathode, an active carbon 20 g as an electrode active material, graphite 2.5 g as a conducting agent, Nafion™ 2.5 g (diluted to 5% in water) as a cation-exchanger were added to ethanol 20 ml and the mixture was stirred for 30 min. to obtain a slurry. For preparing an anode, an activated carbon material 20 g as an electrode active material, graphite 2.5 g as a conducting agent, PVA having 4-formyl-1-methylpyridium benzenesulfonate 2.5 g as an anion-exchanger were mixed to ethanol 20 ml and the mixture was stirred for 6-24 hours to obtain a slurry. The slurry mixture was coated to be a thickness of 150 μm by using an automatic film applicator and a dispenser. The coated film was dried at a temperature of 50 to 200° C. for 2 to 24 hours and the dried film was roll-pressed to provide a film having a thickness of about 120 μm. The film was cut into an appropriate shape and vacuum-dried to use as an anode and a cathode of the supercapacitor.

### EXAMPLE 2

An electrode of the supercapacitor was prepared by employing the same procedure in Example 1, except using PVA having an ammonium group as an anion-exchanger.

### EXAMPLE 3

An electrode of the supercapacitor was prepared by employing the same procedure in Example 1, except using PVA having a pyridinium group as an anion-exchanger.

### COMPARISON EXAMPLE 1

An electrode of the supercapacitor was prepared by employing the same procedure in Example 1, except using a binder instead of an ion-exchanger.

### COMPARISON EXAMPLE 2

An electrode of the supercapacitor was prepared by employing the same procedure in Example 1,except using a cation-exchanger only at the cathode and a binder at the anode.

### EXPERIMENTAL EXAMPLE

C-V characteristics for each supercapacitor was determined and compared. WMPG-1000 of the WonAtech was used. A scan speed was 100 mv/s and sulfuric acid solution was used as an electrolyte. A count electrode having the same size to the sample to determine was used.

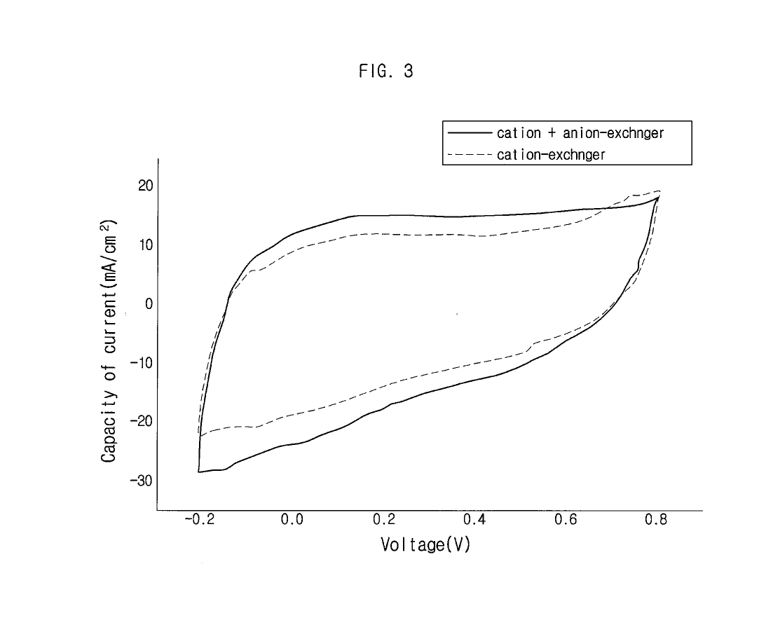

As shown in FIG. 3, the supercapacitor of Example 1 showed about 15 mA/cm² of an electric capacity at a voltage of −0.2V to +0.8V and those of Examples 2 and 3 showed similar results, while the supercapacitor of Comparison Example 2 showed about 10 mA/cm² at the same voltage(the result from Comparison Example 1 was similar). It is thus noted that use of the ion-exchanger significantly increases the electric capacity.

As described above, the electrode of the supercapacitor is prepared by using the ion-exchanger, instead of a binder, eliminates the hindrance of ion transfer associated with the use of a binder and thus improves ion transfer on the surface of the electrode and output performance.

While it has been described with reference to particular embodiments, it is to be appreciated that various changes and modifications may be made by those skilled in the art without departing from the spirit and scope of the embodiment herein, as defined by the appended claims and their equivalents.

What is claimed is:

1. A supercapacitor comprising:
a current collector;
a porous separator;
a cathode prepared by comprising a porous activated carbon material, a conducting agent and a cation-exchanger; and
an anode prepared by comprising a porous activated carbon material, a conducting agent and an anion-exchanger.

2. The supercapacitor of claim 1, wherein both electrodes of the cathode and the anode are prepared by coating the current collector layer by layer with a slurry comprising a porous activated carbon material, a conducting agent, an ion-exchanger and a solvent.

3. The supercapacitor of claim 2, wherein the slurry has 30-40 wt. % of a porous activated carbon material, 1-5 wt. % of a conducting agent, 1-5 wt. % of an ion-exchanger and 50-60 wt. % of a solvent with respect to 100 wt. % of the total slurry.

4. The supercapacitor of claim 2, wherein the electrode layer coated on the current collector has a thickness of 50-200 μm.

5. The supercapacitor of claim 1, wherein the conducting agent is at least one selected from the group consisting of granulated acetylene black, super P black, carbon black, hard carbon, soft carbon, graphite and metal powder.

6. The supercapacitor of claim 1, wherein the porous activated carbon material is at least one selected from the group consisting of carbon coconut shell, petrolic or coal pitch, cokes, phenol resin and polyvinyl chloride.

7. The supercapacitor of claim 1, wherein the cation-exchanger material is at least one selected from the group consisting of poly(2-sulfoethyl methacrylate), poly(diallyldimethylammonium chloride), poly(styrene sulfonate), poly(phosphazene sulfonate), sulfonated polyimide, sulfonated polyphenylene oxide, poly(dimethylphenylene oxide)propionic acid, sulfonated polyurethane, sulfonated polyethersulfone, sulfonated poly(benzimidazole), sulfonated poly(4-phenoxy benzoyl-1,4-phenylene), sulfonated polypropylene, sulfonated polymethyl methacrylate, fluoropolymer-or fluorocopolymer-based sulfonated tetrafluoroethylene, poly(2,4-dimethylphenylene oxide)propenoic acid, sulfonated polyurethane and sulfonated poly(ether ether ketone).

8. The supercapacitor of claim 1, wherein the anion-exchanger is a gel-form or macro porous polymer material having a functional group selected from the group consisting of a quaternary ammonium functional group, a dialkylamino or substituted dialkylamino functional group and an aminoalkylphosphonate or aminodiacetate functional group.

9. The supercapacitor of claim 1, wherein the anion-exchanger is selected from the group consisting of polystyrene resin substituted with a quaternary ammonium group or primary, secondary or tertiary amine and a PVA introduced with a 4-formyl-1-methylpyridium benzenesulfonate, an ammonium group or a pyridinium group.

10. A method for manufacturing an electrode for supercapacitors comprising:
preparing a slurry by mixing a porous activated carbon material, a conducting agent, and an ion-exchanger in a solvent and stirring the result;
coating a current collector with the slurry with a particular thickness and drying the result; and
pressurizing the dried slurry.
